(19) United States
(12) Patent Application Publication
(10) Pub. No.: US 2014/0114760 A1
(43) Pub. Date: Apr. 24, 2014

(54) USING RELEVANT REAL-TIME INFORMATION TO ADAPT ADS

(71) Applicant: MICROSOFT CORPORATION, Redmond, WA (US)

(72) Inventor: DIRK HANS REINSHAGEN, Bellevue, WA (US)

(73) Assignee: MICROSOFT CORPORATION, Redmond, WA (US)

(21) Appl. No.: 13/655,111

(22) Filed: Oct. 18, 2012

(51) Int. Cl. G06Q 30/02

(52) U.S. Cl. 705/14.54; 705/14.4; 705/14.49

(57) ABSTRACT

Methods, systems, and computer-readable media for generating a real-time advertisement are provided. An advertisement candidate that accepts one or more items of real-time data is generated, having one or more advertiser extensions associated with the advertisement candidate. The advertisement extensions accept items of real-time data that are retrieved from an advertiser data provider, according to a mechanism for retrieval of real-time data items. A real-time advertisement is generated, having at least one of the retrieved items of real-time data and the advertisement candidate. Upon receiving a search request from a user, a real-time advertisement may be presented. The real-time advertisement may include items of real-time information incorporated into the advertisement candidate, as well as other advertisement content responsive to parameters of the advertisement API call. Accordingly, the real-time advertisement includes up-to-date, real-time data retrieved from an advertiser data provider, as well as static content of the advertisement candidate.

### CROSS-REFERENCE TO RELATED APPLICATIONS

Not Applicable.

### BACKGROUND

Generally, when presenting advertisements in conjunction with search results, such advertisements do not include the most up-to-date information, or the most relevant items of information that are more likely to elicit a click response from a particular user. In fact, the ad copy for some advertisements includes static data referenced from an advertiser database that is only updateable upon the advertisement provider redesigning the advertisement. That is, advertisements are not configured to automatically accept new information upon changes to a business's current condition, such as the availability of products or services. Further, while a publisher may add content to an advertisement, such as appending annotations to the advertisements that are deemed relevant to a particular user, such annotations are not based on real-time information derived from an advertiser, and will not be able to dynamically react to changes that may occur within a particular timeframe.

### SUMMARY

This Summary is provided to introduce concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer storage media for generating real-time advertisements. In general, the process includes creating an advertisement candidate that serves as a template for generating a real-time advertisement. The advertisement candidate facilitates the presentation of real-time data as part of advertisement extensions. Accordingly, real-time data related to the advertiser placing the advertisement can be injected into the advertisement. For example, an advertisement for a digital camera can include real-time data related to the number of remaining items of inventory for a particular advertiser. Such real-time data may be retrieved and/or updated at the time when a real-time advertisement is presented to a user, or at any other time prior to presentation. Embodiments of the invention provide an automated process that provides real-time advertisement extensions would help create a dynamic advertising experience that generates advertisements with the most relevant, up-to-date information regarding a particular advertiser's products and/or services

In an exemplary embodiment, an advertisement candidate that accepts one or more items of real-time data is generated in response to a search request from a user. The advertisement candidate may be generated by one or more components of an advertisement serving system, such as an ad center and/or an ad-serving engine. The advertisement candidate may include one or more advertiser extensions associated with the advertisement candidate, which are adapted to accept the real-time data items. Items of real-time data are retrieved from an advertiser data provider, according to a mechanism for retrieval of real-time data items. A real-time advertisement is generated, including at least one of the retrieved items of real-time data and the advertisement candidate. A real-time advertisement may be presented in response to the user's search request. The real-time advertisement may include items of real-time information incorporated into the advertisement candidate, as well as other advertisement content that satisfies parameters of an advertisement API call. Accordingly, in one embodiment, a real-time advertisement includes real-time data retrieved from an advertiser data provider, as well as stored ad content from an advertiser database that was used to generate the advertisement candidate. In some embodiments, real-time data items may be retrieved at a second point in time, to update and/or replace the items of real-time data that initially populated the advertisement extensions of the advertisement candidate that first formed the real-time advertisement.

### BRIEF DESCRIPTION OF THE DRAWINGS

Embodiments of the present invention are described in detail below with reference to the attached drawing figures, wherein:

FIG. 1 is a block diagram of an exemplary computing environment suitable for use in implementing embodiments of the present invention;

FIG. 2 is a flow diagram showing exemplary phases of generating a real-time advertisement, in accordance with an embodiment of the present invention;

FIG. 3 is an operational flow diagram illustrating an exemplary system for generating real-time advertisements, in accordance with embodiments of the present invention;

FIG. 4 depicts an exemplary screen display of real-time advertisements presented in conjunction with search results, in accordance with embodiments of the present invention;

FIG. 5 is a flow diagram showing exemplary phases of generating a real-time advertisement, in accordance with an embodiment of the present invention; and

FIG. 6 is a flow diagram showing exemplary phases of generating a real-time advertisement, in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Aspects of the invention relate to systems, methods, and computer readable media for generating real-time advertisements. In general, the process includes creating an advertisement candidate that serves as a template for generating a real-time advertisement. The advertisement candidate facilitates the presentation of real-time data as part of advertisement extensions. Accordingly, real-time data related to the advertiser placing the advertisement can be injected into the advertisement. For example, an advertisement for a digital camera can include real-time data related to the number of remaining items of inventory for a particular advertiser. Such real-time data can be retrieved and/or updated at the time when a real-time advertisement is presented to a user.

As discussed more fully below, embodiments of this invention include generating an advertisement candidate that accepts one or more items of real-time data. The advertisement candidate may include one or more advertiser extensions associated with the advertisement candidate, which are adapted to accept real-time data items. Items of real-time data are retrieved from an advertiser data provider, according to a mechanism for retrieval of real-time data items. In embodiments, a real-time advertisement is generated, having at least one of the retrieved items of real-time data and the content of the advertisement candidate. Upon receiving a search request from a user, a real-time advertisement may be presented. The real-time advertisement may include items of real-time data incorporated into the advertisement candidate, as well as other advertisement content that satisfies the advertisement API call. Accordingly, in one embodiment, the real-time advertisement includes real-time data retrieved from an advertiser data provider, as well as stored ad content from an advertiser database that was used to generate the advertisement candidate.

Accordingly, in a first embodiment, the invention is directed to one or more computer-readable media having computer-executable instructions embodied thereon that, when executed, perform a method for generating a real-time advertisement. The method comprises: generating at least one advertisement candidate that accepts one or more items of real-time data; retrieving one or more items of real-time data, wherein retrieving the one or more items of real-time data comprises invoking a mechanism to retrieve the one or more items of real-time data; and generating a real-time advertisement comprising the one or more retrieved items of real-time data and the at least one advertisement candidate.

In another embodiment, the invention includes one or more computer-readable media having computer-executable instructions embodied thereon that, when executed, perform a method for generating a real-time advertisement. The method comprises: accessing at least one advertisement candidate that accepts one or more items of real-time data, distributing the advertisement candidate to a user device, wherein, upon receiving the advertisement candidate, the user device performs a process comprising: (1) retrieving one or more items of real-time data from an advertiser data provider; and (2) generating a real-time advertisement comprising the one or more retrieved items of real-time data and the at least one advertisement candidate.

In a further embodiment, a computerized method for generating a real-time advertisement includes: transmitting an application programming interface (API) call for advertisement copy that satisfies one or more parameters for generating a real-time advertisement; accessing at least one advertisement candidate that is configured with a template to accept one or more items of real-time data, wherein the at least one advertisement candidate comprises at least one advertisement extension that targets the one or more items of real-time data; retrieving a first set of one or more items of real-time data from an advertiser data provider by invoking a mechanism to select the first set of one or more items of real-time data; and generating a real-time advertisement comprising at least one real-time data item of the retrieved first set of one or more items of real-time data and the at least one advertisement candidate.

Having briefly described an overview of embodiments of the present invention, an exemplary operating environment suitable for implementing embodiments of the present invention is described below.

### Operating Environment

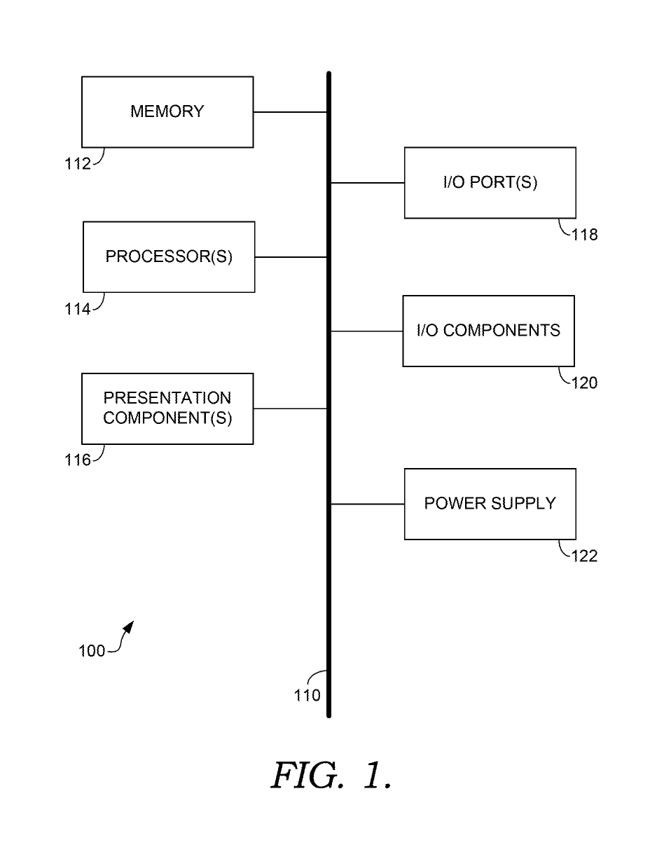

Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. The invention may be practiced in a variety of system configurations, including handheld devices, consumer electronics, general-purpose computers, specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and nonremovable media. By way of example, and not limitation, computer-readable media may comprise computer storage media and communication media. Computer storage media includes volatile and nonvolatile, removable and nonremovable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium, which can be used to store the desired information and which can be accessed by computing device 100. Communication media typically embody computer-readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disk drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

### Advertisement Candidate Generation

In embodiments, an advertisement candidate serves as a template for generating a real-time advertisement. For example, an advertisement candidate may be built to satisfy an application programming interface (API) call for an advertisement, in response to a received trigger, such as a search request from a user.

A set of advertisement (ad) content and/or copy may be retrieved by an advertisement-serving system, in response to an API call for an advertisement. For example, an API call might specify an “inventory call with a stock-keeping unit (SKU).” In that example, for a particular product, an advertisement-serving system may retrieve ad copy (that satisfies the API call) from an advertiser's catalog. The retrieved ad copy may indicate the types of products and the corresponding SKU of those products, as provided by that advertiser, and be used to generate an advertisement candidate and/or set of advertisement candidates.

For example, an advertisement-serving system may retrieve ad copy including a particular model of digital camera. Such data may be used to generate one or more advertisement candidates and/or sets of candidate advertisements. In embodiments, because the information retrieved to create the advertisement candidate(s) is static information retrieved from a database provided by the advertiser, such ad content does not include real-time information.

In embodiments, advertisement candidates are able to accept one or more items of real-time content. As such, advertisement candidates may be generated to include at least one advertisement extension that accepts real-time data. For example, responsive to the API call for inventory and SKU information for a particular product, an advertisement candidate includes static ad copy responsive to the API call, and is also equipped to include one or more advertisement extensions that accept at least one item of real-time data, as will be discussed in further detail below.

### Retrieval of Real-Time Data

A variety of different types of real-time data may be retrieved for incorporation into a real-time advertisement. In embodiments, such information may be directly or indirectly related to the content of the advertisement being presented to a user. For example, the number of tables available at a restaurant, a video feed from a concert venue, a playlist at a dance club or for a band at an upcoming show, and information regarding where parking is available, may all be retrieved as different types of real-time data to incorporate into an advertisement candidate. The real-time data may also include social information, such as the number of people that have checked in to a restaurant, the number of friends that have already checked in to a restaurant using a social media tracking system, and/or the number of friends who plan to check in. In some embodiments, real-time data may include further information, such as geographical information, including the amount of travel time to a venue, or whether the venue is en route to an upcoming meeting. In other examples, real-time data may provide relevant usage information as part of an advertisement, such as discounts ongoing at a golf course, or inventory remaining at a particular retailer.

The type of real-time information that is to be provided (i.e. the real-time data that is to be retrieved) may be indicated by the advertiser. For example, when retrieving real-time data related to inventory at a retailer, the retailer may have previously indicated a desire to present inventory for the most popular selling product.

In embodiments, real-time data may be retrieved by 1) calling directly to the advertiser for the content (i.e. internal sourcing) or 2) accessing a third-party data store (i.e. external sourcing). For example, an advertisement server system may respond to a search request from a user by generating an advertisement candidate that accepts one or more items of data from a particular source(s). The advertiser associated with the advertisement candidate may specifically identify or expose API's that identify the particular source(s) from which to draw the real-time data expected by the advertiser. For example, the advertiser may specify that real-time data is to be retrieved from a hosted service run by the advertiser that returns real-time data, and is therefore considered an “internal” source. In another example, the advertiser may specify that real-time data is to be retrieved from a third party data store, such as an “external” source. Accordingly, whether internal or external, an advertiser data provider may provide real-time data in response to an API that allows the search engine to retrieve the real-time information expected by the advertiser.

### Generating Real-Time Advertisement

In embodiments, generating real-time advertisements is done by inserting the real-time data while the search engine is rendering the advertisement candidate, to provide a real-time advertisement. Accordingly, the most up-to-date information is presented to the user, with the advertisement serving system dynamically pulling real-time data from an API-indicated source. In embodiments, real-time advertisements are presented “on the fly” when the real-time information is incorporated into the advertisement candidate, and in one example, replacing placeholders for advertisement extensions with the retrieved real-time data. As such, the real-time advertisement is enhanced with real-time data, and presented to a user.

In another embodiment, an advertisement candidate may be generated at a first point in time and presented to a user. At a second point in time, real-time data may then be inserted into the advertisement candidate, and the user will be presented with an updated real-time advertisement that includes one or more items of real-time data. In one example, such a delayed updating of the advertisement candidate, and subsequent completion of the real-time advertisement, may be accomplished using a script within the advertisement candidate that pulls in the content of the real-time data once the advertisement candidate is posted. In another example, script within an advertisement candidate may modify content when a change has occurred to real-time data at an internal or external source targeted by the API (i.e. the real-time advertisement is improved as subsequent real-time data becomes available.) In that example, the advertisement candidate may be updated with real-time extensions that reflect the most up-to-data data. In a further example, an API may designate that real-time data must be updated after a threshold amount of time. For example, script may determine that inventory cannot be more than five minutes old, so a threshold may be set to retrieve updated, real-time inventory data at a particular time point.

In generating the real-time advertisement, further logic could be built into the advertisement candidate that evaluates the content of the retrieved real-time data. In other words, the logic could interpret the results of the API, make a determination based on the content, and provide alternative actions (such as, for example, retrieving different pieces of real-time data, or eliminating certain data based on certain other factors). In one embodiment, the determination may involve either identifying the content as acceptable to use or identifying the content as unacceptable to use. When the content is unacceptable to use, the logic may invoke an ancillary API to retrieve secondary real-time data. Or, in another example, the logic may simply insert default copy into the advertisement until such time that the content of the initial real-time information is deemed acceptable. This may involve the logic recursively checking the source targeted by the primary API (with the original API being the “primary” API, and subsequent API's being secondary, etc.).

Accordingly, in the example of providing real-time data indicating table availability at a restaurant, the real-time advertisement may provide an item of information that is not acceptable (such as indicating in an advertisement for the restaurant that no tables are currently open). In response, the advertisement may then retrieve information on availability of tables at a future time, or in the alternative, may revert to displaying a reservation applet. In another example, if an advertisement for a retailer indicates that no inventory is available for a certain item, the real-time advertisement may instead present a favorable review for a product sold by the advertiser.

In another embodiment, the APIs associated with a real-time advertisement may alternate based on searching context, such as the identity of the user or the temperature outside. For example, there may be a determination using a piece of data that one API should be invoked over all others. For example, with regard to the example of outside temperature, a restaurant advertiser may select the API that is directed to copy about margarita specials when it is hot outside, while an API that is directed to soup is selected when it is cold outside.

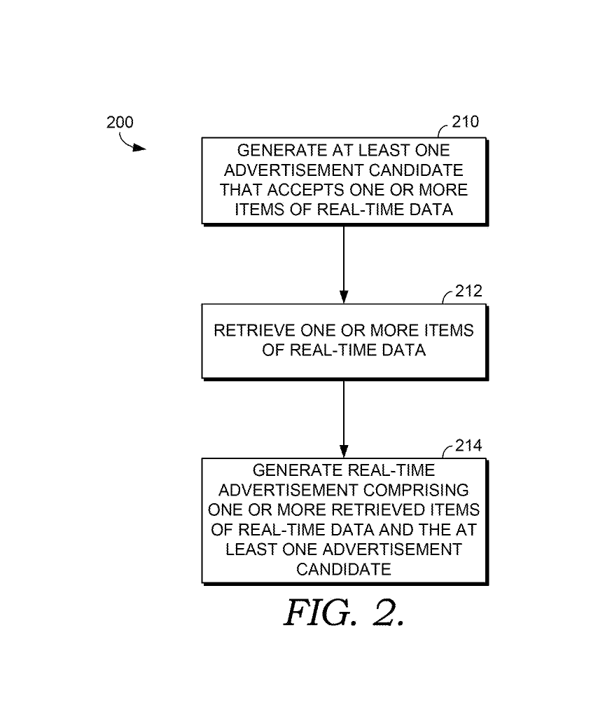

Accordingly, with reference now to FIG. 2, an exemplary method 200 of generating a real-time advertisement is provided. At block 210, an advertisement candidate that accepts real-time data is generated. As discussed above, an advertisement candidate may include one or more extensions that accept real-time data. In some embodiments, ad content and/or ad copy is transmitted in response to an API call for an advertisement, such as in response to a search request submitted by a user. At block 212, one or more items of real-time data are retrieved, according to a mechanism for retrieval of such real-time data. For example, in the various mechanisms discussed above, real-time data may be retrieved directly or indirectly from an advertiser data provider. Finally, at block 214, a real-time advertisement is generated, including real-time data and the advertisement candidate. Accordingly, the ad copy/content retrieved from the advertiser (as part of the advertisement candidate) is augmented with real-time data. For example, an ad extension that accepts real-time data may be populated with real-time data that is retrieved at the time a search request is submitted. Additionally, in some embodiments, a subsequent retrieval of real-time data is used to update the real-time data at a second time.

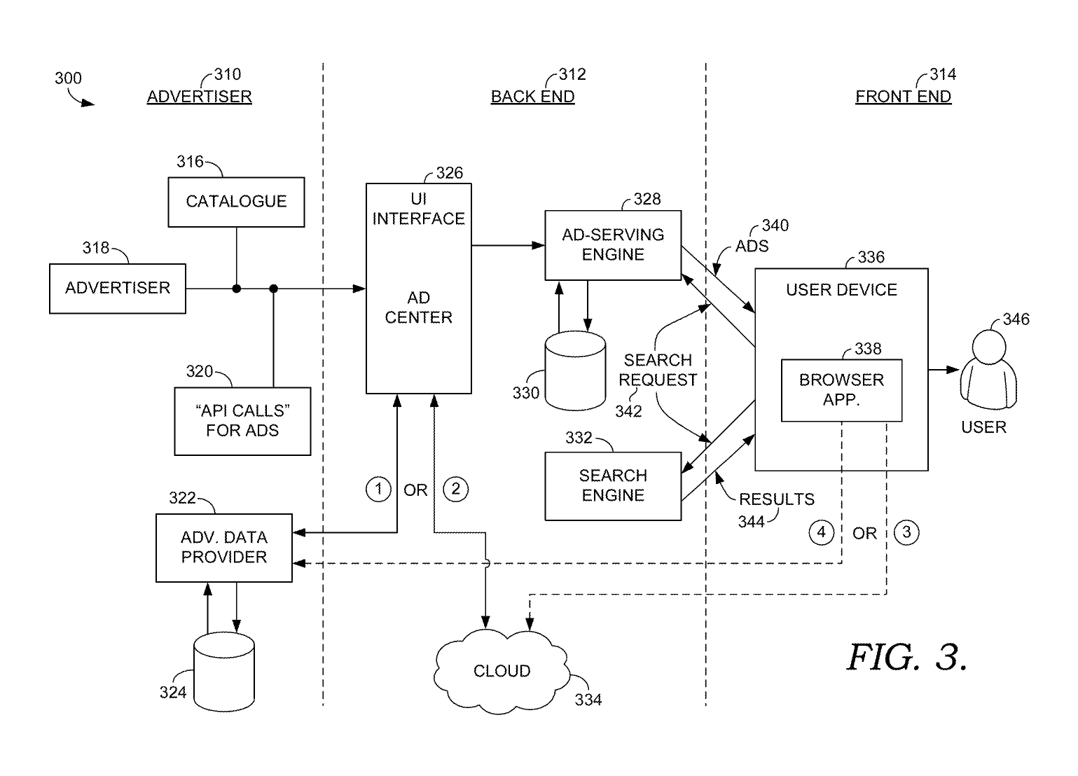

Referring next to FIG. 3, an operational flow diagram illustrates an exemplary system 300 for generating real-time advertisement extensions. The system 300 is depicted from three perspectives: the advertiser perspective 310, the back end 312 that generates advertisements, and the front end 314 that receives the advertisements. Accordingly, from the advertiser perspective 310, a catalogue 316 of advertiser data is provided by the advertiser 318, for providing in response to API calls for ads 320. Although not necessarily directly related to the advertiser 318 (such as when accessed via an external and/or third party source), the advertiser data provider 322 provides real-time data related to the advertiser 318. Advertiser data provider 322 may be any source from which real-time data may be retrieved, such as a website that is accessible by one or more elements of the system 300. In embodiments, advertiser data provider 322 stores information related to advertiser 318 in a database 324. As will be understood, advertiser data provider 322 provides real-time data, such as, for example, live inventory numbers, current prices, current table availability, and other types of dynamic information. As such, in embodiments, information stored, accessed, and/or transmitted by database 324 and/or advertiser data provider 322 is continuously updated.

From the perspective of the back end 312, an advertisement serving system includes an ad center 326 and an ad-serving engine 328. As will be understood, one or both of the ad center 326 and the ad-serving engine 328 may be referred to as an “advertisement serving system,” without limiting the functionality of either component or requiring one or both elements. The advertisement serving system (via ad center 326) receives advertiser information for constructing an advertisement candidate, based on one or more of the catalogue 316, the advertiser 318, and the API call for ads 320. Further, as can be seen at point 1, ad center 326 may communicate directly to advertiser data provider 322 to retrieve real-time data responsive to the API call for an advertisement. In another embodiment, ad center 326 may communicate via another source to retrieve real-time data, such as via cloud-based source 334. In other words, the retrieval of real-time data to populate an extension of an advertisement candidate may be done by referencing another source, such as an internet-based source or other external data supplier.

In one embodiment, ad-serving engine 328 may capture data retrieved in response to an API call, and store such data in database 330. In another embodiment, ad-serving engine 328 may make a determination of which items of real-time data (i.e. which enhancements) should be used to generate the real-time advertisement. Such a determination may be based, for example, on which real-time data items will make it more likely for a user 346 to click on the real-time advertisement. In one embodiment, ad-serving engine 328 may contain the logic to 1) select an advertisement (generate the advertisement candidate) and 2) select items of real-time data to populate an advertisement extension. As a default rule, in one example, the ad-serving engine 328 may require that no extension be displayed in association with an advertisement. However, in another example, if the ad-serving engine 328 determines that a particular user would be more likely to click on a real-time advertisement that includes a particular type of up-to-date, real-time data (such as the current availability of a table, or the quickly-diminishing inventory of a product), the ad-serving engine 328 may direct and/or select such real-time data items.

In further embodiments, while the advertisement serving system is accessing advertisement data via ad center 326, compiling advertisement candidates via ad-serving engine 328, and retrieving items of real-time data from advertiser data provider 322 for insertion into the advertisement candidate and presentation to a user as part of a real-time advertisement, search engine 322 is responding to the same search request 342. In other words, a search request 342, received on the back end 312, triggers both the generation of advertisements 340 and the retrieval of search results 344, such that search engine 322 and ad-serving engine 328 run in parallel.

Accordingly, on the front end 314, a user device 336, having a browser application 338 receives a search request 342 from a user 346. As previously discussed, real-time data from advertiser data provider 322 may be retrieved at the time an advertisement candidate is published to a user 346. For example, the browser application 338 of a user device 336 may initiate the retrieval of real-time data based on a script of the advertiser candidate. In one embodiment, at point 3, the user device 336 retrieves data from an external source, such as the cloud 334. In further embodiments, at point 4, the user device 336 retrieves real-time data directly from advertiser data provider 322. Accordingly, real-time data retrieved by user device 336 (via browser application 338) may be incorporated into one or more extensions of an advertisement candidate and presented to the user 346 as a real-time advertisement. As described above, in embodiments where the updating of real-time data occurs on the front end 314, real time data may be retrieved and updated a second time, after an initial presentation of the real-time advertisement to the user 346.

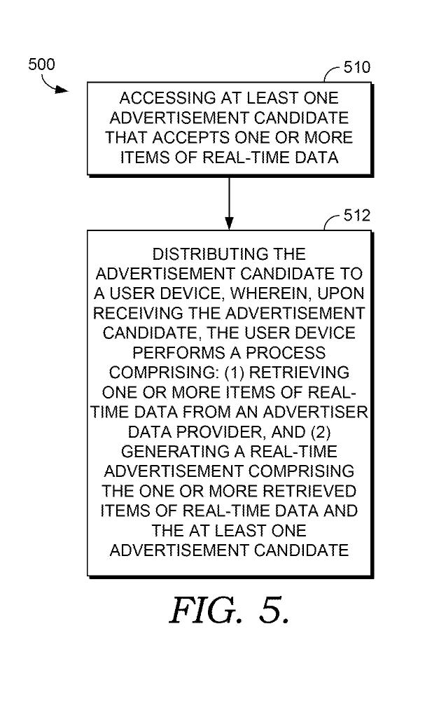

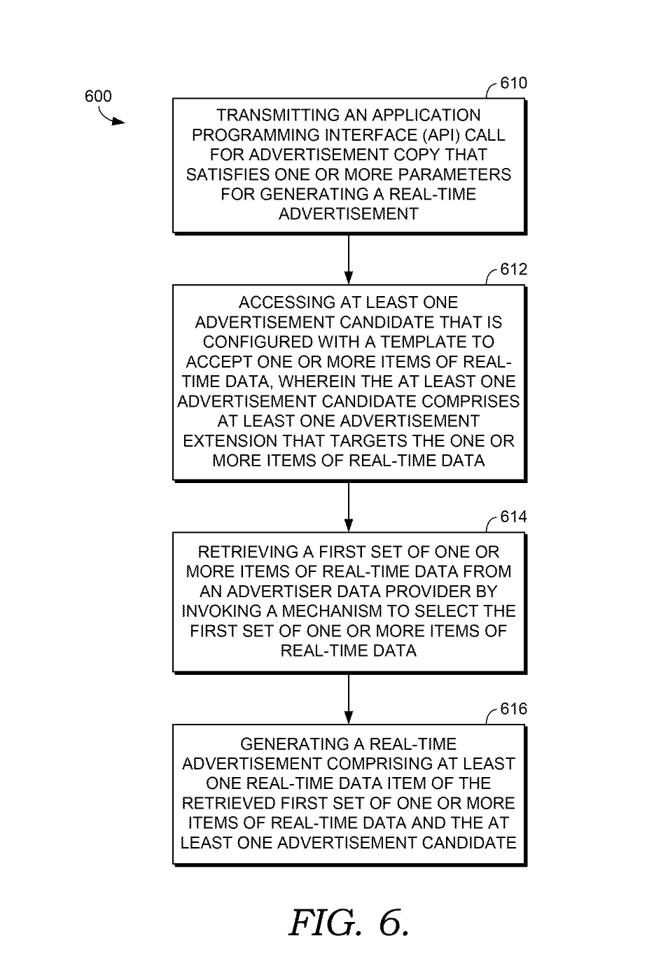

Accordingly, additional exemplary methods of generating real-time advertisements are provided in FIGS. 5 and 6. Referring first to FIG. 5, an exemplary method 500 of generating a real-time advertisement is provided. At block 510, an advertisement candidate that accepts real-time data is accessed. As discussed above, an advertisement candidate may include one or more extensions that accept real-time data. At block 512, the advertisement candidate is distributed to a user device, wherein, upon receiving the advertisement candidate, the user device performs a process comprising: (1) retrieving one or more items of real-time data from an advertiser data provider, and (2) generating a real-time advertisement comprising the one or more retrieved items of real-time data and the at least one advertisement candidate.

With reference now to FIG. 6, an exemplary method 600 for generating a real-time advertisement is provided. At block 610, an application programming interface (API) call is transmitted for advertisement copy that satisfies one or more parameters for generating a real-time advertisement. At block 612, at least one advertisement candidate is accessed, which is configured with a template to accept one or more items of real-time data, wherein the at least one advertisement candidate comprises at least one advertisement extension that targets the one or more items of real-time data. Accordingly, at block 614, a first set of one or more items of real-time data are retrieved from an advertiser data provider by invoking a mechanism to select the first set of one or more items of real-time data. Finally, at block 616, a real-time advertisement is generated comprising at least one real-time data item of the retrieved first set of one or more items of real-time data and the at least one advertisement candidate.

### User Interface

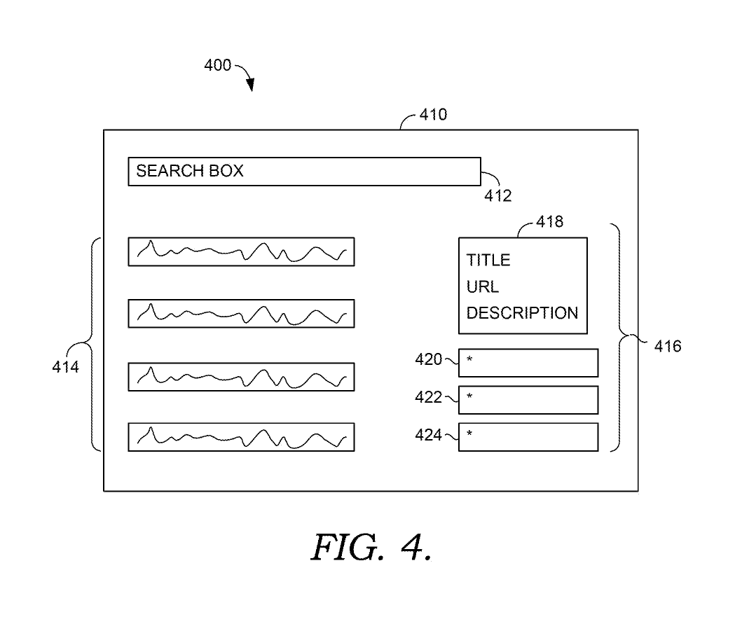

Referring next to FIG. 4, an exemplary user interface 400 includes a display 410 having a search box 412 where a user enters a search request. In embodiments, in response to the search request received by search box 412, one or more search results 414 may be provided to a user. Additionally, in response to the same search request, an advertisement candidate 416 may be presented in association with search results 414. Advertisement candidate 416 may include one or more items of ad content 418 that make up an advertisement candidate 416. For example, the advertisement candidate 416 may include core advertisement information, such as a title, a description, a URL, and the like. Advertisement candidate 416 also includes advertisement extensions 420, 422, and 424, which are able to accept items of real-time data. As discussed above, in some embodiments, real-time data retrieved from an advertiser data provider may be populated into one or more of the advertisement extensions 420, 422, and 424, to provide a real-time advertisement.

Embodiments of the present invention have been described in relation to particular embodiments, which are intended in all respects to be illustrative rather than restrictive. Alternative embodiments will become apparent to those of ordinary skill in the art to which embodiments of the present invention pertain without departing from its scope.

From the foregoing, it will be seen that this invention is one well adapted to attain all the ends and objects set forth above, together with other advantages, which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media having computer-executable instructions embodied thereon that, when executed, perform a method for generating a real-time advertisement, the method comprising:
generating at least one advertisement candidate that accepts one or more items of real-time data;
retrieving one or more items of real-time data, wherein retrieving the one or more items of real-time data comprises invoking a mechanism to retrieve the one or more items of real-time data; and
generating a real-time advertisement comprising the one or more retrieved items of real-time data and the at least one advertisement candidate.

2. The computer-readable media of claim 1, wherein generating at least one advertisement candidate comprises transmitting an application programming interface (API) call for advertisement copy that satisfies one or more parameters.

3. The computer-readable media of claim 2, wherein generating at least one advertisement candidate comprises generating at least one advertisement extension that accepts real-time data.

4. The computer-readable media of claim 3, wherein retrieving the one or more items of real-time data comprises retrieving one or more items of real-time data from an advertiser data provider.

5. The computer-readable media of claim 4, wherein retrieving the one or more items of real-time data from an advertiser data provider comprises retrieving one or more items of real-time data responsive to the API call.

6. The computer-readable media of claim 4, wherein retrieving the one or more items of real-time data from an advertiser data provider comprises retrieving at least one item of real-time data from the advertiser data provider that is accepted by the advertisement candidate.

7. The computer-readable medium of claim 4, wherein providing a mechanism to retrieve the one or more items of real-time data comprises accessing the advertiser data provider prior to providing the real-time advertisement to a user.

8. The computer-readable medium of claim 1, wherein the method further comprises receiving an indication of a search request from a user.

9. The computer-readable medium of claim 7, wherein the method further comprises transmitting the real-time advertisement to the user in response to the received indication of a search request.

10. One or more computer-readable media having computer-executable instructions embodied thereon that, when executed, perform a method for generating a real-time advertisement, the method comprising:
accessing at least one advertisement candidate that accepts one or more items of real-time data,
distributing the advertisement candidate to a user device, wherein, upon receiving the advertisement candidate, the user device performs a process comprising:
(1) retrieving one or more items of real-time data from an advertiser data provider; and
(2) generating a real-time advertisement comprising the one or more retrieved items of real-time data and the at least one advertisement candidate.

11. The computer-readable media of claim 10, wherein generating at least one advertisement candidate that accepts one or more items of real-time data comprises transmitting an application programming interface (API) call for advertisement copy that satisfies one or more parameters for generation of an advertisement.

12. The computer-readable media of claim 10, wherein accessing at least one advertisement candidate comprises generating at least one advertisement extension that accepts real-time data.

13. The computer-readable media of claim 12, wherein retrieving the one or more items of real-time data from an advertiser data provider comprises retrieving one or more items of real-time data responsive to the API call.

14. The computer-readable media of claim 13, wherein retrieving the one or more items of real-time data from an advertiser data provider comprises retrieving at least one item of real-time data from the advertiser data provider that is accepted by the at least one advertisement extension.

15. The computer-readable media of claim 10, wherein generating a real-time advertisement comprising at least one of the retrieved one or more items of real-time data and the at least one advertisement candidate comprises populating one or more advertisement extensions with at least one of the one or more items of real-time data.

16. The computer-readable media of claim 10, wherein the method further comprises receiving an indication of a search request submitted by a user, wherein generating the at least one advertisement candidate is based on the received indication of a search request.

17. A computerized method for generating a real-time advertisement, the method comprising:
transmitting an application programming interface (API) call for advertisement copy that satisfies one or more parameters for generating a real-time advertisement;
accessing at least one advertisement candidate that is configured with a template to accept one or more items of real-time data, wherein the at least one advertisement candidate comprises at least one advertisement extension that targets the one or more items of real-time data;
retrieving a first set of one or more items of real-time data from an advertiser data provider by invoking a mechanism to select the first set of one or more items of real-time data; and
generating a real-time advertisement comprising at least one real-time data item of the retrieved first set of one or more items of real-time data and the at least one advertisement candidate.

18. The computer-readable medium of claim 17, wherein invoking a mechanism to retrieve the one or more items of real-time data comprises accessing the advertiser data provider prior to providing the real-time advertisement to a user.

19. The computer-readable medium of claim 17, wherein the method further comprises receiving an indication of a search request from a user and generating the real-time advertisement to the user in response to the received indication of a search request.

20. The computer-readable medium of claim 17, wherein the method further comprises:
retrieving a second set of one or more items of real-time data from an advertiser data provider, wherein retrieving the second set of one or more items of real-time data comprises invoking a mechanism to retrieve the second set of one or more items of real-time data; and
generating a real-time advertisement comprising at least one real-time data item of the retrieved second set of one or more items of real-time data and the at least one advertisement candidate.
